(19) United States
(12) Patent Application Publication
(10) Pub. No.: US 2026/0061525 A1
(43) Pub. Date: Mar. 5, 2026

(54) METHOD FOR CHECKING AN OPTICAL ELEMENT OF A LASER PROCESSING DEVICE FOR CONTAMINANTS

(71) Applicant: TRUMPF Werkzeugmaschinen SE + Co. KG, Ditzingen (DE)

(72) Inventor: Karsten Scholz, Leonberg (DE)

(21) Appl. No.: 19/381,002

(22) Filed: Nov. 6, 2025

Related U.S. Application Data
(63) Continuation of application No. PCT/EP2024/061354, filed on Apr. 25, 2024.

(30) Foreign Application Priority Data
May 11, 2023 (DE) 10 2023 112 412.9

(51) Int. Cl. B23K 26/70; G01M 11/00; G02B 27/00

(52) U.S. Cl. CPC B23K 26/707; B23K 26/705; G01M 11/00; G02B 27/0006

(57) ABSTRACT

A method for checking an optical element of a laser processing device for contaminants is provided. A laser beam passes through the optical element. The method includes measuring scattered light emanating from the optical element by an optical sensor. N individual measurements are carried out, where N≥3. During each respective individual measurement i, the laser beam passes through the optical element. The scattered light emanating from the optical element is measured by the optical sensor. A respective signal strength Sᵢ is determined at the optical sensor. For the N individual measurements i, different diameters Dᵢ of the laser beam at the optical element are set. The method further includes ascertaining information about a location-dependent contaminant of the optical element based on the signal strengths Sᵢ of the N individual measurements, where i=1 . . . N and i is a measurement index.

### CROSS REFERENCE TO RELATED APPLICATIONS

This application is a continuation of International Application No. PCT/EP2024/061354 (WO 2024/231120 A1), filed on Apr. 25, 2024, and claims benefit to German Patent Application No. DE 10 2023 112 412.9, filed on May 11, 2023. The aforementioned applications are hereby incorporated by reference herein.

### FIELD

Embodiments of the present invention relate to a method for checking an optical element of a laser processing device for contaminants, wherein the optical element is passed by a laser beam, in particular caused to radiate therethrough, and scattered light emanating from the optical element is measured with an optical sensor.

### BACKGROUND

Laser processing is a frequently used and efficient method for processing workpieces. Laser cutting allows workpieces to be cut out of metal sheets and other materials in a simple and efficient manner, for example, without the need for a workpiece-specific cutting tool. For example, laser welding can be used to quickly and reliably join partial workpieces together to form a single workpiece.

When laser processing workpieces, a laser beam from a laser source is usually directed onto the workpiece using a laser processing head. The laser beam is typically focused on the surface of the workpiece or in a specific plane near the surface of the workpiece. The laser processing head has optical elements, in particular lenses and protective glasses, through which the laser beam passes.

Laser processing of the workpiece itself or other processes can lead to contamination of the optical elements. For example, molten workpiece material can splash onto the optical element, or dust particles can be introduced into the laser processing head during maintenance work. If the laser beam passes through a contaminated optical element, in particular is caused to radiate therethrough, the contaminants can locally shadow the laser beam, which can impair the processing result on the workpiece. In addition, the optical element heats up more rapidly at the location of the contamination. Such local heating can lead to the optical imaging properties of the optical element being changed, at least locally, by thermal expansion. The position and shape of a focus of the laser beam can be changed or distorted. Contamination can also occur globally on an optical element, for example due to oil components contained in a cooling gas, which can be introduced into the cooling gas by pumping. Such global contamination leads to an overall attenuation of a passing laser beam and to a general heating of the optical element during operation. For example, it is known from DE 20 2010 006 047 U1 that increased absorption of a protective glass caused by contaminants can be determined by measuring the temperature.

To determine the degree of contamination of an optical element in a laser processing device, an optical sensor can be directed at the optical element to measure scattered light emanating from the optical element, which is caused by the passing laser beam. The greater the contamination of the optical element, the more scattered light is generated and the higher the signal registered on the sensor. If the signal on the sensor is too high, the workpiece processing can be aborted and the optical element can be cleaned or replaced.

This procedure provides integral information about the degree of contamination of the optical element within the cross-section occupied by the laser beam. If, for example, a local contaminant is located in a radial edge area of the optical element, laser processing, in particular laser cutting, could in many cases still be continued without having to accept a significant loss of quality in the laser processing of the workpiece. It may be possible to change the laser processing of workpieces to a process where the detected contaminants would be acceptable due to its location, for example by using a narrower laser beam that does not illuminate the detected contaminants. Accordingly, in many cases, laser processing with a laser processing device is stopped, even though further laser processing of workpieces would still be possible.

### SUMMARY

Embodiments of the present invention provide a method for checking an optical element of a laser processing device for contaminants. A laser beam passes through the optical element. The method includes measuring scattered light emanating from the optical element by an optical sensor. N individual measurements are carried out, where N≥3. During each respective individual measurement i, the laser beam passes through the optical element. The scattered light emanating from the optical element is measured by the optical sensor. A respective signal strength Sᵢ is determined at the optical sensor. For the N individual measurements i, different diameters Dᵢ of the laser beam at the optical element are set. The method further includes ascertaining information about a location-dependent contaminant of the optical element based on the signal strengths Sᵢ of the N individual measurements, where i=1 . . . N and i is a measurement index.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1a schematically illustrates a first individual measurement with a smallest diameter D1 of the laser beam at the location of an optical element, in longitudinal section along the beam propagation direction, for an exemplary variant of a method according to the invention for checking the contamination of an optical element of a laser processing device, according to some embodiments;

FIG. 1b illustrates for the variant of FIG. 1a a second individual measurement with a mean diameter D2, according to some embodiments;

FIG. 1c illustrates for the variant of FIG. 1a a third individual measurement with a largest diameter D3, according to some embodiments;

FIG. 2a schematically illustrates the first individual measurement for the variant of FIG. 1a, with a cross-section at the location of the optical element, according to some embodiments;

FIG. 2b illustrates the second individual measurement for the variant of FIG. 2a, according to some embodiments;

FIG. 2c illustrates the third individual measurement for the variant of FIG. 2a, according to some embodiments;

FIG. 3 schematically illustrates the measurement situation for the three individual measurements for the variant of FIG. 1a, with a cross-section at the location of the optical element (left), with contamination in the area between D2 and D3, and with an associated diagram of the measured signal strengths (right), according to some embodiments;

FIG. 4 schematically illustrates a measurement situation for three individual measurements similar to the variant of FIG. 1a, with a cross-section at the location of the optical element (left), but with contamination in the area between D1 and D2, and with an associated diagram of the measured signal strengths (right), according to some embodiments;

FIG. 5 schematically illustrates a measurement situation for three individual measurements similar to the variant of FIG. 1a, with a cross-section at the location of the optical element (left), but with contamination in the area within D1, and with an associated diagram of the measured signal strengths (right), according to some embodiments;

FIG. 6 schematically illustrates the measurement situation for the three individual measurements similar to the variant of FIG. 1a, with a cross-section at the location of the optical element, for a bias measurement without contamination, according to some embodiments;

FIG. 7a schematically illustrates an exemplary embodiment of a laser processing device according to the invention, wherein the adjusting device is used to set a smallest diameter D1 of the laser beam on the optical element, according to some embodiments;

FIG. 7b illustrates the embodiment of FIG. 7a, wherein the adjusting device is used to set a mean diameter D2 of the laser beam on the optical element, according to some embodiments;

FIG. 7c illustrates the embodiment of FIG. 7a, wherein the adjusting device is used to set a largest diameter D3 of the laser beam on the optical element, according to some embodiments;

FIG. 8 schematically illustrates an exemplary design of a laser processing head of a laser processing device for the invention, wherein a protective glass is monitored with a sensor as the optical element, according to some embodiments;

FIG. 9 schematically illustrates an exemplary design of a laser processing head of a laser processing device for the invention, wherein a beam splitter is monitored with a sensor as the optical element, according to some embodiments; and

FIG. 10 schematically illustrates an exemplary design of a laser processing head of a laser processing device for the invention, wherein a lens is monitored with a sensor as the optical element, according to some embodiments.

### DETAILED DESCRIPTION

Embodiments of the invention provide a method for checking an optical element of a laser processing device, with which more information about contaminants on an optical element can be obtained in a simple manner, in particular in order to enable a higher availability of the laser processing device.

According to embodiments of the invention, in the method for checking an optical element of a laser processing device, N individual measurements are carried out, where N≥3; wherein during each individual measurement i the laser beam passes through the optical element and scattered light emanating from the optical element is measured by the optical sensor, and a signal strength Sᵢ is determined at the optical sensor; for the individual measurements i different diameters Dᵢ of the laser beam at the location of the optical element are set, and information about a location-dependent contaminant of the optical element is ascertained from the signal strengths Sᵢ of the N individual measurements, where i=1 . . . N and i: measurement index.

According to some embodiments, it is provided that when measuring the scattered light, at least three individual measurements are carried out, which take place with different diameters of the laser beam at the location of the optical element (wherein the location of the optical element is related to the beam propagation direction). Preferably, to change the diameter at the location of the optical element, the beam divergence of the laser beam is changed, typically wherein the focus diameter of the laser beam is changed. For a given beam parameter product, a smaller focus diameter is associated with a larger beam divergence and vice versa.

Depending on the position and size of a local contamination (local contaminant), it is illuminated by the laser beam in all or only part of the individual measurements, and in this case completely, only partially or not at all, and accordingly contributes to the generation of scattered light, which is measured by the sensor. Accordingly, the signal strengths Sᵢ of the N individual measurements provide information about the location-dependent contaminant of the optical element.

During the individual measurements, the laser beam typically remains aligned and centered along an optical axis. This makes it easy to obtain information about the radial distribution of the contaminant of the optical element about the optical axis. In addition, the laser power typically remains unchanged across the individual measurements. The latter is particularly easy to control and improves the comparability of individual measurements.

If, for example, there is local contamination (such as a dust particle) in a radial edge area of the optical element, this will only enter the cross-section of the laser beam at large diameters of the laser beam and only then will it contribute to the scattered light. Conversely, a local contaminant near the beam axis of the laser beam will be illuminated at all diameters of the laser beam and will therefore contribute to the scattered light in all individual measurements.

With the spatially resolved information on the contamination of the optical element, it is possible to decide on an improved basis whether a planned laser processing process with the laser processing device (also called a laser processing machine) is still feasible in the current state of contamination or not. Likewise, on an improved basis with the spatially resolved information on the contamination of the optical element, a process for further laser processing of workpieces can be selected that is still feasible with the laser processing device in the current state of contamination. As a result, the measuring method according to embodiments of the invention can be used to provide the necessary information for improved availability (improved utilization) of the laser processing device.

Typical optical elements that can be checked for contaminants using the method according to embodiments of the invention are lenses and protective glasses, possibly also mirrors, including curved mirrors and semi-transparent mirrors, apertures, beam splitters, diffractive optical elements, or filters. A typical optical sensor for measuring scattered light is a photodetector, in particular a zero-dimensional photodetector, which is essentially directed laterally onto the optical element. During scattered light measurement, the laser beam passes through the optical element, typically by being caused to radiate through the optical element; however, it is also possible that the laser beam is reflected at the optical element and thus passes through the optical element.

In a preferred variant of the method according to embodiments of the invention, from the signal strengths Sᵢ, which increase from a larger diameter Dᵢ to a smaller diameter Dᵢ, an increased degree of contamination of the optical element within the smaller diameter Dᵢ is inferred. In this way, initial, qualitative information about the location-dependent contaminant can be easily obtained. If there is local contamination (only or predominantly) in the area of the smaller diameter, reducing the diameter of the laser beam from the larger to the smaller diameter (with constant total power of the laser) leads to a higher radiation density in the area of contamination, and thus to more scattered light. The increase in signal strength (relative or absolute) can also be used to approximately quantitatively infer the degree of contamination within the smaller diameter compared to the larger diameter (more on this below).

In an equally preferred variant, from the signal strengths Sᵢ, which increase from a smaller diameter Dᵢ to a larger diameter Dᵢ, an increased degree of contamination of the optical element outside the smaller diameter Dᵢ is inferred. In this way, initial, qualitative information about the location-dependent contaminant can also be easily obtained. If there is local contamination (only or predominantly) in the area of the larger diameter, it does not enter the cross-section of the laser beam at the smaller diameter of the laser beam, but only at the larger diameter of the laser beam, and only then does it contribute to the scattered light. This effect usually outweighs a reduction in the local radiation density due to an increase in the beam diameter (at constant total laser power). The increase in signal strength (relative or absolute) can be used to approximately quantitatively infer the degree of contamination within the larger diameter (and outside the smaller diameter) compared to within the smaller diameter (more on this below).

A variant is preferred in that from the signal strengths Sᵢ a degree of contamination G₁ of the optical element within a smallest diameter D₁ and respective degrees of contamination Gⱼ of the optical element in the area between the diameter Dⱼ and the diameter Dⱼ₋₁ are determined, where j=2 . . . N and j: counting index of the remaining larger diameters. The degrees of contamination G₁, Gⱼ within the smallest diameter D₁ and the respective surrounding rings within Dⱼ₋₁ to Dⱼ can be used to make an intuitively interpretable assessment of the location-dependent contaminant and, if necessary, to optimize the utilization of the laser processing machine in a simple and targeted manner. It is to be noted that alternatively, integral degrees of contamination within the respective diameters Dᵢ can also be determined.

A further development of this variant is particularly preferred in which the degrees of contamination G₁, Gⱼ are determined iteratively from a smallest diameter D₁ up to a largest diameter D_{N}. This makes it easy to determine the degrees of contamination G₁, Gⱼ. The contamination G₁ can be directly determined from S₁. The contamination within the outer rings Gⱼ can then be determined, for example, from the inside to the outside with the values Sⱼ and G₁ to Gⱼ₋₁ (which can be deducted from a raw contamination Gⱼ^{roh} determined from Sⱼ for the entire inner area of the diameter Dⱼ). Alternatively, the degrees of contamination Gⱼ can also be determined using the values Sⱼ and Sⱼ₋₁, or alternatively using the values Sⱼ and Sᵢ to Sⱼ₋₁, see also below.

A further development of the above variant is also preferred in that in a step 1) from a signal strength S₁ for a smallest diameter D1 a degree of contamination G₁ of the optical element within the smallest diameter D₁ is inferred, and from the signal strength S₁ an expected signal contribution C₂ in the signal S₂ of the next larger diameter D₂ is determined by contamination of the optical element within the smallest diameter D₁, and in that in further steps j) from a respective corrected signal strength KSⱼ=Sⱼ−Cⱼ for the diameter Dⱼ to a degree of contamination Gⱼ of the optical element in an area between the diameter Dⱼ and the diameter Dⱼ₋₁ is inferred, and from the signal strength Sⱼ or alternatively from the signal strengths S₁ to Sⱼ an expected signal contribution Cⱼ₊₁ in the signal Sⱼ₊₁ of the next larger diameter Dⱼ₊₁ is determined by a contaminant of the optical element within the diameter Dⱼ. This procedure is simple and efficient for determining the degrees of contamination G₁ to G_{N}. It is understood that in the last step N) a determination of C_{N+1} is no longer required.

An advantageous sub-variant of this further development provides for the signal contributions Cⱼ to be determined at least approximately according to

$${C}_{j} = {S}_{j - 1} * {[ {D}_{j - 1} / {D}_{j} ]}^{2} .$$

This simple estimate can contribute to a very accurate estimation of the location-dependent contaminant. This estimate is based on the assumption that the signal contribution Cⱼ in the larger diameter Dⱼ due to contaminants within the next smaller diameter Dⱼ₋₁ is essentially proportional to the signal strength Sⱼ₋₁ of the next smaller diameter and also proportional to the ratio of the area of the smaller diameter Dⱼ₋₁ to the area of the larger diameter Dⱼ. The latter takes into account a redistribution of the total beam power of the laser beam (assumed to be constant) when changing the diameter, which is assumed to be the main factor for the scattered light intensity caused by contaminants in the smaller diameter. If desired, the accuracy of the determination of Cⱼ can be increased by a correction factor Fⱼ specific for j in the above formula, which can be determined by calibration. For an even more precise determination of the signal contributions Cⱼ, these can be calculated as the sum of m summands, each of which is determined specifically for the areas assigned for the Gₘ, where m=1 . . . j−1 and m: index of smaller diameters.

A sub-variant of the above further development is also preferred, in which the degrees of contamination G₁ to G_{N} are determined at least approximately according to

$${G}_{1} = F * {S}_{1} * {[ {D}_{1} ]}^{2} and$$

$${G}_{j} = F * {KS}_{j} * [ {( {D}_{j} )}^{2} - {( {D}_{j - 1} )}^{2} ] ,$$

where F: proportionality constant. With this simple estimate, the degrees of contamination can be easily compared. The area of a ring area located farther out is (with the same ring width) comparatively large compared to ring areas located farther in. Accordingly, the laser power is then distributed over a larger area, and signal strengths due to the scattered light generated become weaker (in the case of local contaminants of a similar size and nature). By multiplying by a factor proportional to the respective ring area, which in Gⱼ is then [(Dⱼ)²−(Dⱼ₋₁)²], the area-related signal strength attenuation can be equalized. It is to be noted that alternatively the degrees of contamination G₁, Gⱼ can also be determined (without weighting via the areas) via G₁=F′*S₁ and Gⱼ=F′*KSⱼ, where F′: alternative proportionality constant.

Furthermore, a further development of the above variant is preferred which provides that the degrees of contamination G₁, Gⱼ are converted into remaining availabilities V₁, Vⱼ within the smallest diameter D₁ for V₁ or within the area between Dⱼ and Dⱼ₋₁ for a respective Vⱼ,
in particular wherein the degrees of contamination G₁, Gⱼ are each assigned maximum values M₁, Mⱼ, upon reaching which the laser processing becomes no longer usable and the remaining availabilities V₁, Vⱼ are calculated as

$${V}_{1} = 1 - {G}_{1} / {M}_{1} and$$

$${V}_{j} = 1 - {G}_{j} / {M}_{j} ,$$

and in particular wherein the remaining availabilities V₁, Vⱼ are displayed on the laser processing device. The determination of remaining availabilities, in particular via M₁, Mⱼ and V₁, Vⱼ, allows users of the laser processing device an intuitive and application-related understanding of the degree of contamination, and facilitates further planning of the production of workpieces or the selection of further workpiece processing processes to be carried out.

Another preferred variant is one which provides that, before further evaluation of the signal strengths Sᵢ, the signal strengths Sᵢ are adjusted by a bias after their measurement by subtracting a basic signal strength Bᵢ from the respective signal strength Sᵢ, which was obtained with the optical element in a contaminant-free state with the corresponding laser beam with the diameter Dᵢ. This makes the determination of the location-dependent contaminant even more accurate. Bias correction taking an offset into account is particularly recommended if noticeable scattered light occurs in the laser processing head regardless of the contamination of the optical element being inspected, for example due to surface roughness of the optical element or scattering at locations away from the optical element.

Alternatively or additionally, it may be provided that for further evaluation of the signal strengths Sᵢ, the signal strengths Sᵢ are set in relation to a bias after their measurement in order to determine a degree of contamination, which corresponds to a state of contamination in relation to a clean state. This makes the determination of the location-dependent contaminant even more accurate. Bias correction taking a factor into account is particularly recommended if noticeable scattered light occurs in the laser processing head regardless of the contamination of the optical element being inspected, for example due to surface roughness of the optical element or scattering at locations away from the optical element.

Embodiments of the present invention also include a method for operating a laser processing device,
wherein an optical element of the laser processing device is checked for contaminants,
characterized in that
the checking of the optical element of the laser processing device for contaminants is carried out according to a method according to embodiments of the invention described above,
in that a decision is made on the basis of a result of the check as to whether a scheduled process of laser processing a workpiece can be carried out with the laser processing device or not, and in that in the decision as to whether the scheduled process can be carried out or not, at least the determined location-dependent information about the contaminant of the optical element and information about the diameter(s) of the laser beam on the optical element to be used within the scope of the scheduled process are taken into account. If the current location-dependent contaminant of the optical element and the diameter(s) of the laser beam to be used for the scheduled process at the location of the optical element are taken into account when deciding whether or not a scheduled process can still be carried out, unnecessary downtimes of the laser processing device can be minimized.

Embodiments of the present invention also includes a method for operating a laser processing device, wherein an optical element of the laser processing device is checked for contaminants,
characterized in that
the checking of the optical element of the laser processing device for contaminants is carried out according a method according to embodiments of the invention described above, and
in that if the determined information about the location-dependent contaminant of the optical element shows that relevant contaminants are present only in a radial edge area of the optical element, but not in a central region of the optical element, the laser processing device remains ready for operation with the proviso that until the optical element is cleaned or replaced, only processes for laser processing workpieces are carried out in which the diameter of the laser beam at the optical element remains within the central region. This procedure means that in the event of relevant contaminants (which precludes further operation), the laser processing device only remains available in the radial edge area, at least for certain processes which, in particular, only require the laser beam to be guided in the central area of the optical element. With appropriate planning or rescheduling of the processes, downtimes of the laser processing device can be minimized.

In an advantageous variant of the above two methods for operating a laser processing device, the optical element of the laser processing device is checked for contaminants:
after each maintenance or repair on a laser processing head of the laser processing device; and/or
after each predetermined operating time of the laser processing device; and/or
on each start-up of the laser processing device; and/or
before each start of a new process for laser processing of workpieces; and/or
on manual triggering.

This ensures a high processing quality of the workpieces. At the same time, good availability of the laser processing device can be achieved.

Embodiments of the present invention also includes a laser processing device, comprising
a laser source for providing a laser beam,
an optical element through which the laser beam passes, in particular caused to radiate therethrough,
an adjusting device for adjusting a diameter of the laser beam at the location of an optical element,
an optical sensor for measuring scattered light emanating from the optical element, and an
electronic control device,
characterized in that
the electronic control device is configured to carry out, in an automated sequence, a method for checking the optical element of the laser processing device for contaminants according to a method according to embodiments of the invention described above,
wherein the electronic control device is configured to successively set different diameters Dᵢ of the laser beam at the location of the optical element for the N individual measurements with the adjusting device and to determine an associated signal strength Sᵢ at the optical sensor with the respective diameter Dᵢ. This laser processing device can be used to locally detect contaminants on the optical element and achieve high availability for workpiece processing.

An embodiment of the laser processing device is preferred in which the laser processing device is a laser cutting device. In laser cutting, the cutting processes can often be varied with little effort and without any significant loss of quality with regard to the diameter of the laser beam at the location of an optical element, which means that a particularly high level of availability can be achieved in the event of contaminants only in the radial edge area of the optical element.

The features mentioned above and the features still to be explained may each be used on their own or together in any desired combinations according to embodiments of the invention.

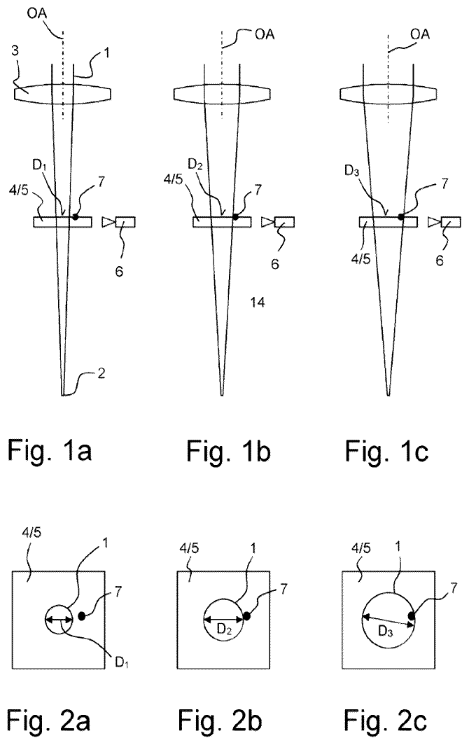

FIGS. 1a to 1c and FIGS. 2a to 2c illustrate an exemplary variant of a method according to embodiments of the invention for checking the contamination of an optical element of a laser processing device using three individual measurements. FIGS. 1a to 1c each show longitudinal sections along the beam propagation direction through a part of a laser processing head of the laser processing device close to the workpiece to be processed, and FIGS. 2a to 2c each show cross-sections at the location of the optical element.

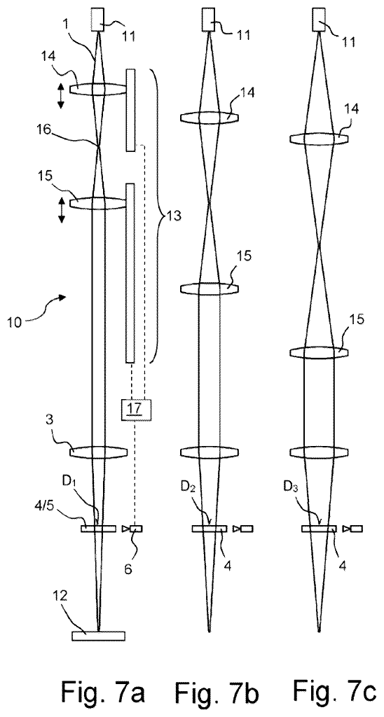

As can be seen in Figure la, the laser processing device directs a laser beam 1 onto a workpiece (not shown, but see FIG. 7a for this purpose), wherein a focus 2 of the laser beam 1 typically lies on the workpiece surface. In the illustrated variant, the laser beam 1 is focused by a lens 3, wherein the laser beam 1 passes through an optical element 4, here a protective glass 5, located between the lens 3 and the focus 2. The protective glass 5 may be contaminated, for example as a result of splashes of molten workpiece material, or simply dust particles. As an example, local contamination 7 in the form of a dust particle is illustrated here. An optical sensor 6 is directed onto the optical element 4 from the side and measures scattered light emanating from the optical element 4. Scattered light is primarily generated by contaminants 7 on the optical element 4 when the laser beam 1 is scattered by the contaminants 7.

According to some embodiments, several individual measurements of the scattered light are carried out, wherein each time a different diameter Di of the laser beam 1 is used at the location of the optical element 4. In all cases, the laser beam 1 remains centered on a common optical axis OA and the laser power is kept constant. However, the beam divergence is changed to change the diameter Dᵢ at the location of the optical element (more on this in FIG. 7a-7c).

In the first individual measurement of Figure la and FIG. 2a the smallest diameter D₁ is used. Since the contamination 7 is outside the diameter D₁ of the laser beam 1, this does not contribute to the generation of scattered light.

The second individual measurement of FIG. 1b and FIG. 2b is made with a mean diameter D₂ of the laser beam 1 at the location of the optical element 4. In this case, the contamination 7 is also outside of D₂ and therefore does not contribute to the generation of scattered light in the second individual measurement.

The third individual measurement of FIG. 1c and FIG. 2c is carried out with the largest diameter D₃ of the laser beam 1 at the location of the optical element 4. Now the contamination 7 is within D₃, and therefore contributes to the generation of scattered light.

In the contamination situation shown of FIGS. 2a to 2c, a noticeable signal strength due to scattered light will therefore only be achieved in the third individual measurement with D₃. This makes it easy to infer that there is only noticeable contamination in the area between D₂ and D₃.

It is understood that the individual measurements illustrated in FIGS. 1a to 1c and FIGS. 2a to 2c can be carried out in any order. It should also be noted that according to the invention, four, five or even more individual measurements (with additional diameters D4, D5, etc.) can be carried out.

In the following, typical contamination situations on an optical element, which are checked using a method according to embodiments of the invention, will be discussed qualitatively and quantitatively using examples. It is assumed that three individual measurements as shown in FIGS. 1a-1c and FIGS. 2a-2c are carried out with the diameters D₁, D₂ and D₃ of the laser beam at the location of the optical element, wherein here D₁=1.0 mm, D₂=1.5 mm and D₃=2.0 mm were selected. The diameter of the laser beam can be determined using the 86% criterion (86% of the laser power lies within a circle with the specified diameter). In these measurements, the signal strengths S₁, S₂ and S₃ are measured, for example using a photocurrent (unit: milliampere, mA).

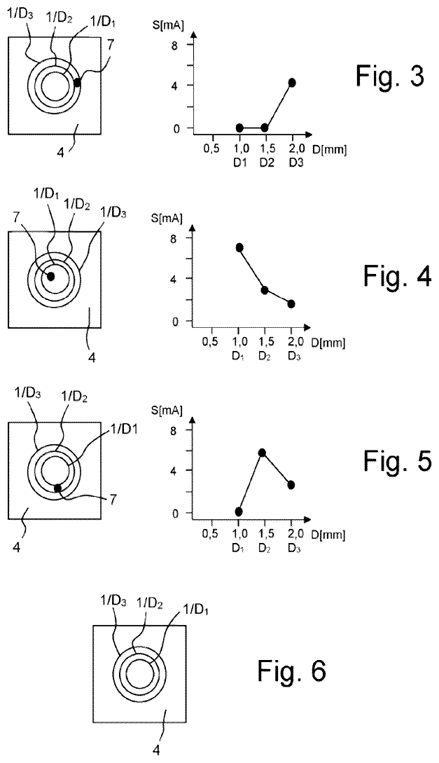

FIG. 3 shows the contamination situation as already discussed in FIGS. 1a-1c and 2a-2c. As can be seen in the left-hand cross-section of FIG. 3, a single local contaminant 7 is located in the area between D2 and D3. Typical corresponding measured values of signal strengths S and Sᵢ for the corresponding diameters D and Dᵢ are shown in the right-hand diagram of FIG. 3 and in the following Table 1 (along with other values):

TABLE 1
Exemplary measured values in the situation of FIG. 3

| | Individual | | Single | | Single | |
|---|---|---|---|---|---|---|
| | measurement 1 | | measurement 2 | | measurement 3 | |
| Situation of FIG. 3 | i = 1 | | i = 2 | | i = 3 | |
| Diameter Dᵢ of the | D₁ = 1.0 | mm | D₂ = 1.5 | mm | D₃ = 2.0 | mm |
| laser beam | | | | | | |
| Signal strength Sᵢ of | S₁ = 0.040 | mA | S₂ = 0.052 | mA | S₃ = 4.150 | mA |
| scattered light [mA] | | | | | | |

| | | | | | |
|---|---|---|---|---|---|
| Signal contribution | — | C₂ = 0.018 | mA | C₃ = 0.029 | mA |
| Cₖ [mA] | | | | | |
| Corrected signal | — | KS₂ = 0.034 | mA | KS₃ = 4.121 | mA |
| strength KSᵢ | | | | | |

| | | | |
|---|---|---|---|
| Degree of | G₁ = 0.040 | G₂ = 0.043 | G₃ = 7.212 |
| contamination Gᵢ | | | |
| (where F = 1/mA) | | | |
| Maximum value Mᵢ | M₁ = 7.5 | M₂ = 15 | M₃ = 30 |
| Remaining | V₁ = 0.995 | V₂ = 0.997 | V₃ = 0.760 |
| availability Vᵢ | | | |

Since the (in the example only) local contamination 7 is located outside of D₂, as shown in FIG. 3, a clear signal strength S₃ is only obtained at the sensor for the scattered light in the third individual measurement, which takes place with the diameter D₃. The signal strengths S₁, S₂ are, in contrast, much smaller.

In the situation of FIG. 4 the only local contamination 7 is located within the innermost diameter D₁, see the left-hand cross-section in FIG. 4. As can be seen in the right-hand diagram of FIG. 4 and in Table 2, a high signal strength S₁ is obtained in the first individual measurement i=1. Since this local contamination 7 is also located within D₂ and within D₃, noticeable signal strengths S₂ and S₃ are also measured. Since the beam power of the laser beam 1 is distributed over a larger area in the individual measurements i=2 and i=3, the scattered light intensity (and thus the measured signal strength S) decreases with the increasing diameter D of the laser beam 1.

TABLE 2
Exemplary measured values in the situation of FIG. 4

| | Individual | | Individual | | Individual | |
|---|---|---|---|---|---|---|
| | measurement | | measurement | | measurement | |
| Situation of FIG. 4 | i = 1 | | i = 2 | | i = 3 | |
| Diameter Dᵢ of the | D₁ = 1.0 | mm | D₂ = 1.5 | mm | D₃ = 2.0 | mm |
| laser beam | | | | | | |
| Signal strength Sᵢ of | S₁ = 7.134 | mA | S₂ = 3.221 | mA | S₃ = 1.860 | mA |

| scattered light [mA] | | | | | |
|---|---|---|---|---|---|
| Signal contribution | — | C₂ = 3.170 | mA | C₃ = 1.812 | mA |
| Cₖ [mA] | | | | | |
| Corrected signal | — | KS₂ = 0.051 | mA | KS₃ = 0.048 | mA |
| strength KSᵢ | | | | | |

| | | | |
|---|---|---|---|
| Degree of | G₁ = 7.134 | G₂ = 0.064 | G₃ = 0.084 |
| contamination Gᵢ | | | |
| (where F = 1/mA) | | | |
| Maximum value Mᵢ | M₁ = 7.5 | M₂ = 15 | M₃ = 30 |
| Remaining | V₁ = 0.049 | V₂ = 0.996 | V₃ = 0.997 |
| availability Vᵢ | | | |

In the situation of FIG. 5, the only local contamination 7 is arranged in the area between D₁ and D₂, see the left-hand cross-section in FIG. 5. Accordingly, the signal strength S₂ of the sensor for scattered light is greatest in the second individual measurement. The contamination 7 also has an effect on the third individual measurement i=3, and a noticeable signal strength S₃ is obtained, albeit lower than S₂, as the laser power is distributed over a larger area from D₂ to D₃. In the first individual measurement for D₁, only a minimal signal strength S₁ is obtained because the contamination 7 is not within D₁. All this can be seen in the right-hand diagram in FIG. 5 or Table 3.

TABLE 3
Exemplary measured values in the situation of FIG. 5

| | Individual | | Individual | | Individual | |
|---|---|---|---|---|---|---|
| | measurement | | measurement | | measurement | |
| Situation of FIG. 5 | i = 1 | | i = 2 | | i = 3 | |
| Diameter Dᵢ of the | D₁ = 1.0 | mm | D₂ = 1.5 | mm | D₃ = 2.0 | mm |
| laser beam | | | | | | |
| Signal strength Sᵢ of | S₁ = 0.040 | mA | S₂ = 5.622 | mA | S₃ = 3.198 | mA |

| scattered light [mA] | | | | | |
|---|---|---|---|---|---|
| Signal contribution | — | C₂ = 0.018 | mA | C₃ = 3.162 | mA |
| Cₖ [mA] | | | | | |
| Corrected signal | — | KS₂ = 5.604 | mA | KS₃ = 0.036 | mA |

| | | | |
|---|---|---|---|
| strength KSᵢ | | | |
| Degree of | G₁ = 0.040 | G₂ = 7.005 | G₃ = 0.063 |
| contamination Gᵢ | | | |
| (where F = 1/mA) | | | |
| Maximum value Mᵢ | M₁ = 7.5 | M₂ = 15 | M₃ = 30 |
| Remaining | V₁ = 0.995 | V₂ = 0.533 | V₃ = 0.998 |
| availability Vᵢ | | | |

Now the degree of contamination G₁ is to be determined for the area within D₁, the degree of contamination G₂ is to be determined for the annular area between D₁ and D₂, and the degree of contamination G₃ is to be determined for the annular area between D₂ and D₃.

According to embodiments of the invention, this can be done “from the inside out”. Assuming an approximately uniform illumination of the cross-section of the laser beam for all beam diameters D₁, D₂ and D₃, the signal strength Sⱼ₋₁ for an inner diameter Dⱼ₋₁ (index value j−1) can be used to determine an expected signal contribution Cⱼ due to contaminants in this inner diameter for the signal strength Sⱼ for the next larger beam diameter Dⱼ (index value j) according to

$${C}_{j} = {S}_{j - 1} * {[ {D}_{j - 1} / {D}_{j} ]}^{2}$$

where j: index of the (larger) diameters, starting at j=2 and running up to N, here where N=3. It should be noted that here [D₁/D₂]²−0.4444 and [D₂/D₃]²=0.5625. This expected signal contribution Cⱼ can then be used to determine a corrected signal strength

$${KS}_{j} = {S}_{j} - {C}_{j}$$

for the outermost (annular) areas; note that the innermost area (within D₁) does not require such a correction. The corrected signal strengths KSⱼ therefore describe the respective signal strength that is due to scattered light from contaminants in the respective annular area from Dⱼ₋₁ to Dⱼ, i.e., without a respective signal strength that is due to scattered light from contaminants within the diameter Dⱼ₋₁. The corresponding values of Cⱼ and KSⱼ for the different situations of FIGS. 3, 4 and 5 are entered in Tables 1, 2 and 3 respectively.

In order to obtain a comparable degree of contamination of the respective areas, the degree of contamination G₁, Gⱼ in a particular area can now be determined according to

$${G}_{1} = F * {S}_{1} * {[ {D}_{1} ]}^{2} and$$

$${G}_{j} = F * {KS}_{j} * [ {( {D}_{j} )}^{2} - {( {D}_{j - 1} )}^{2} ] ,$$

where F: proportionality constant, in Tables 1, 2 and 3 above simply selected as 1/mA. The factor [(Dⱼ)²−(Dⱼ₋₁)²] compensates for the lower power density of the laser beam in the case of an increasing beam diameter. It should be noted that here [(D₂)²−(D₁)²]=1.25 and [(D₃)²−(D₂)²]=1.75. The respective values G₁, Gⱼ then correspond approximately to the absolute quantity (size/area) of scattering contaminants in the respective associated area. These values are also entered in Tables 1, 2 and 3.

In the cases of FIGS. 3, 4 and 5 and Tables 1, 2 and 3, it can be seen that in the examples similarly large contaminants are present in the respective area. In FIG. 3/Table 1 in the area between D₂ and D₃, G₃=7.212, and G₁, G₂ are each <0.1. In FIG. 4/Table 2 in the area within D₁, G₁=7.134, and G₂, G₃ are each <0.1. In FIG. 5/Table 3 in the area D₁ to D₂, G₂=7.005, and G₁, G₃ are each <0.1. This means that the measurements and evaluations using Gᵢ can be used to trace the exact location of the respective contamination.

In practice, a large number of individual, smaller contaminants (e.g., dust particles, splashes of workpiece material) typically contribute to the overall contamination of the optical element 4, which are distributed over the various areas of the optical element 4. A maximum degree of contamination can be determined experimentally for each area, here called Mᵢ, in which laser processing of a workpiece is no longer possible (with sufficient quality). In this case, the values M₁=7.5, M₂=15 and M₃=30 were determined or specified for the laser processing device. In other words, more contaminants can be accepted in the outer areas than in the inner areas, which can generally be considered a preferred specification according to embodiments of the invention and is suitable for many laser cutting processes.

The formula

$${V}_{i} = 1 - {G}_{i} / {M}_{i}$$

can be used to determine the remaining availability Vᵢ of the optical element in the respective range which is to be assigned to the index value i. In the case of Gᵢ>Mᵢ then Vᵢ=0. Vᵢ can also be expressed as a percentage.

As can be seen from Tables 1, 2 and 3, the contaminants in FIGS. 3, 4 and 5, which are comparable in size, mean that in the case of the contamination 7 in the innermost area of FIG. 4, this area within D₁ is already almost exhausted, with a remaining availability of only V₁=0.049 or 4.9%. In contrast, in the case of FIG. 3 with the contamination 7 in the radially outermost area, between D₂ and D₃, with a remaining availability V₃=0.760 or 76%, this area is only exhausted to a small extent. In the case of FIG. 5, with the contamination 7 in the middle ring area between D₁ and D₂, the remaining availability V₂ is at 0.533 or 53.3%.

The area-specific degrees of contamination Gᵢ or the area-specific remaining availabilities Vᵢ represent typical information about a location-dependent contaminant (also called spatially resolved contaminant information) via the optical element.

Based on the area-specific remaining availabilities Vᵢ, an electronic control device can estimate whether the laser processing device is still generally operational. For such a check, for example, minimum values (here also designated MINᵢ) of remaining availability can be specified for the individual areas. A simple general operational readiness check could, for example, require that in each area at least 10% remaining availability Vᵢ must be available before the next process on a workpiece is started (i.e., MINᵢ≥10% for all i, i=1 to N). For higher quality requirements, higher minimum values MINᵢ, e.g., at least 50%, can also be provided.

Preferably, embodiments of the invention provide that specific minimum values of remaining availabilities for a process execution are assigned to individual scheduled processes of workpiece processing (also referred to as MIN(p)ᵢ, where p: process indicator, and i: index of individual measurements or measured diameters). These individual specific minimum values MIN(p)ᵢ of remaining availabilities then contain information about the diameter of the laser beam to be used in the scheduled process (specified by p). An electronic control device can then use a comparison of the remaining availabilities Vᵢ with the specific minimum values MIN(p)ᵢ to assess whether a specific scheduled process (corresponding to p) may still be started or not. A start is possible if MIN(p)ᵢ≥Vᵢ for all i.

A scheduled process where p=X, which, for example, only uses laser beams with diameters of D₂ or smaller (in a “central area”) specifies, for example, MIN(X)₁=25% and MIN(X)₂=25% and MIN(X)₃=0%; the availability in the third area of D₂ to D₃ is irrelevant for this process, since this process X does not use any laser power in the area greater than D₂ (in a “radial edge area”) and is therefore “zero”. If, in this example, remaining availabilities of, for example, V₁=77% and V₂=88% and V₃=0% have been determined experimentally for the laser processing device, then this process X can be authorized without any problems, even though the optical element is completely contaminated in the third area from D₂ to D₃ (in the “radial edge area”), as can be seen from V₃=0%.

In an analogous manner, the electronic control device can select from workpiece processing processes that are suitable for an upcoming processing task, the respective sets of minimum values MIN(p)ᵢ of which are fulfilled by the remaining availabilities Vᵢ determined experimentally as shown above. Processes that are suitable for the processing task at hand and the respective sets of minimum values MIN(p)ᵢ of which are no longer fulfilled by the remaining availabilities Vi are blocked as long as the optical element has not been cleaned or replaced. The laser processing device remains available for workpiece processing as long as one or more processes remain, the sets of minimum values MIN(p)ᵢ of which are still fulfilled by the currently remaining availabilities Vᵢ. As a rule, the latter is the case if the relevant contaminants detected essentially only affects the radial edge area of the optical element, but not the central area. Then a laser beam that is narrow (radially) at the location of the optical element can still be used well.

In order to enable an even more accurate estimation of the degree of contamination in the individual areas, a bias correction can be carried out. FIG. 6 shows a schematic cross-section of the optical element 4, which is measured without contaminants in three individual measurements i=1, 2, 3 with laser beam diameters D₁, D₂ and D₃ (at the location of the optical element) by the sensor for scattered light. Basic signal strengths Bᵢ are obtained; see the entries in Table 4. The respective basic signal strength can be based, for example, on scattering from the roughness of the contaminant-free surface of the optical element or scattering in front of or behind the optical element and, if necessary, multiple scattering.

These basic signal strengths Bᵢ can be subtracted from the “raw” (directly measured, not yet bias-corrected) signal strengths of the sensor for scattered light, designated Sᵢ^{roh} in Table 4, from the individual measurements of the contaminant check. As an example, the signal strengths Sᵢ from Table 3 were taken as unadjusted signal strengths in Table 4. With the signal strengths Sᵢ=Sᵢ^{roh}−Bᵢ adjusted in this way, the calculations shown above can then be carried out with improved accuracy (not explained further).

TABLE 4
Exemplary bias correction of the signal strengths Sᵢ

| | Individual | | Individual | | Individual | |
|---|---|---|---|---|---|---|
| Bias measurement of | measurement | | measurement | | measurement | |
| FIG. 6 | i = 1 | | i = 2 | | i = 3 | |
| Basic signal strength | B₁ = 0.033 | mA | B₂ = 0.036 | mA | B₃ = 0.030 | mA |
| Bᵢ | | | | | | |
| Unadjusted signal | S₁^{roh} = 0.040 | mA | S₂^{roh} = 5.622 | mA | S₃^{roh} = 3.198 | mA |
| strength Sᵢ ^{roh} of | | | | | | |
| scattered light [mA] | | | | | | |
| Adjusted signal | S₁ = 0.007 | mA | S₂ = 5.586 | mA | S₃ = 3.168 | mA |
| strength Sᵢ of | | | | | | |
| scattered light [mA] | | | | | | |

In the example shown here, the basic signal strengths are quite low compared to the signal strengths with scattered light due to contaminants, which is also a common occurrence in practice; in this case, bias correction results in only a minor change in the calculation of the degree of contamination or the spatially resolved determination of contamination. However, if contamination-independent scattered light (e.g., due to surface roughness) plays a significant role, bias correction can significantly improve the accuracy of spatially resolved determination of contamination.

FIG. 7a shows an exemplary embodiment of a laser processing device 10 according to embodiments of the invention in the region of a laser processing head in a schematic longitudinal section.

The laser beam 1 emerges divergently from a laser source 11, for example, the end of an optical fiber connected to a laser oscillator (not shown in detail). The laser beam 1 is collimated by the two lenses 14 and 15 of a collimation system, wherein the lens 14 images an exit pupil of the laser source 11 into an intermediate focus 16, and wherein the intermediate focus 16 lies in front of the lens 15 at the distance of its focal length. The laser beam 1 is then focused onto the surface of a workpiece 12 using the lens 3. The laser beam 1 passes through the optical element 4, which is designed here as a protective glass 5. An optical sensor 6 is directed onto the optical element 4 and registers scattered light from the optical element 4.

At the location of the optical element 4, the laser beam 1 in FIG. 7a has a diameter D₁ for a first individual measurement. In order to adjust this diameter for further individual measurements of the scattered light of the optical element 4, the laser processing device 10 has an adjusting device 13. With this adjusting device 13, the location of the lens 14 and the location of the lens 15 can be changed along the beam propagation direction. The sensor 6 and the adjusting device 13 are connected to an electronic control device 17 with which the individual measurements of the scattered light can be carried out automatically.

The laser processing device 10 here is a laser cutting device with which cuts can be made in the workpiece 12. The workpiece 12 can be a metal sheet, for example.

In FIG. 7b the lens 14 has been moved slightly away from the laser source 11 using the adjusting device (no longer shown in detail for simplification), and the lens 15 has been moved slightly away from the lens 14 in accordance with the imaging requirements. This resulted in a slightly larger diameter D₂ at the location of the optical element 4.

In FIG. 7c the lens 14 has been moved a little farther away from the laser source 11 using the adjusting device (no longer shown in detail for simplification), and the lens 15 has been moved a little farther away from the lens 14 in accordance with the imaging requirements. This resulted in an even larger diameter D₃ at the location of the optical element 4.

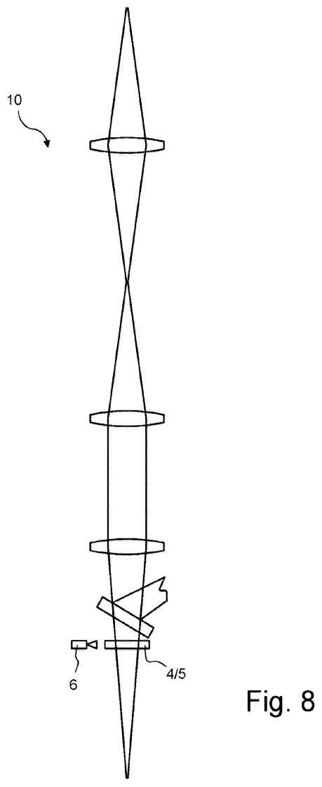

FIGS. 8, 9 and 10 illustrate typical optical elements and their positions in a laser processing device 10, which can be examined for contaminants. The laser processing device 10 largely corresponds to the laser processing device shown in FIG. 7a (see there).

In the design shown in FIG. 8, the optical sensor 6 monitors a protective glass 5 as the optical element 4 for contaminants and measures scattered light emanating from the protective glass 5 at different laser beam diameters.

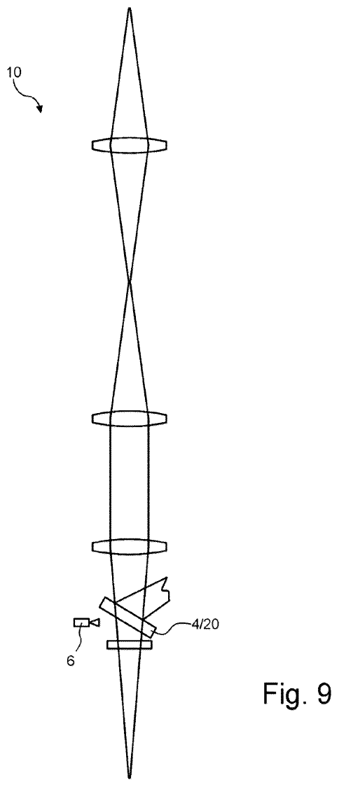

In the design shown in FIG. 9, the sensor 6 monitors a beam splitter 20 or a semi-transparent mirror as optical element 4 for contaminants. For example, the semi-transparent mirror can couple out thermal radiation emanating from the processing location on the workpiece for process monitoring in order to analyze it.

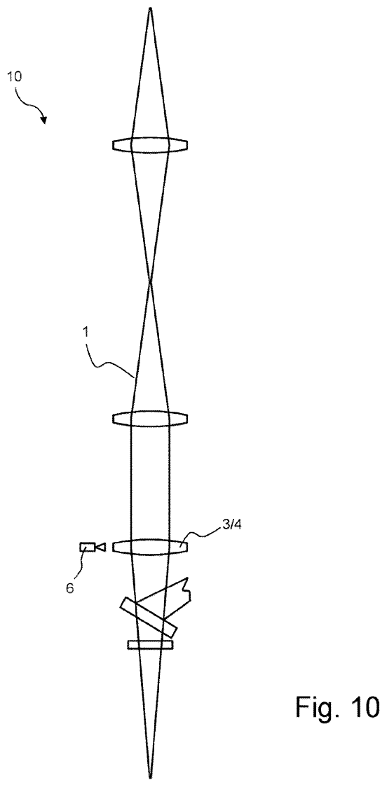

In the design of FIG. 10, the optical element 4 monitored by the sensor 6 is the lens 3 with which the laser beam 1 is focused onto the workpiece (not shown).

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Laser beam
2 Focus
3 Lens (focusing lens)
4 Optical element
5 Protective glass
6 optical sensor
7 (Local) contamination
10 Laser processing device
11 Laser source
12 Workpiece
13 Adjusting device
14 Lens (of the collimation system)
15 Lens (of the collimation system)
16 Intermediate focus
17 Electronic control device
20 Beam splitter/semi-transparent mirror
D Diameter of the laser beam (general)
D₁, D₂, D₃ Diameter of the laser beam
OA Optical axis
S Signal strength (general)

1. A method for checking an optical element of a laser processing device for contaminants, wherein a laser beam passes through the optical element, the method comprising:
measuring scattered light emanating from the optical element by an optical sensor, wherein:
N individual measurements are carried out, where N≥3, during each respective individual measurement i, the laser beam passes through the optical element, the scattered light emanating from the optical element is measured by the optical sensor, and a respective signal strength Sᵢ is determined at the optical sensor, wherein for the N individual measurements i, different diameters Dᵢ of the laser beam at the optical element are set, and
ascertaining information about a location-dependent contaminant of the optical element based on the signal strengths Sᵢ of the N individual measurements, where i=1 . . . N and i is a measurement index.

2. The method according to claim 1, wherein from the signal strengths Sᵢ that increase from a larger diameter Dᵢ to a smaller diameter Dᵢ, an increased degree of contamination of the optical element within the smaller diameter Dᵢ is inferred.

3. The method according to claim 1, wherein from the signal strengths Sᵢ that increase from a smaller diameter Dᵢ to a larger diameter Dᵢ, an increased degree of contamination of the optical element outside the smaller diameter Dᵢ is inferred.

4. The method according to claim 1, wherein from the signal strengths Sᵢ, a first degree of contamination G₁ of the optical element within a smallest diameter D₁, and a respective degree of contamination Gⱼ of the optical element in an area between a jth diameter Dⱼ and a (j−1)th diameter Dⱼ₋₁ are determined, where j=2 . . . N and j is a counting index of remaining larger diameters.

5. The method according to claim 4, wherein the first degree of contamination G₁ and the respective degree of contamination Gⱼ are determined iteratively from the smallest diameter D₁ up to a largest diameter D_{N}.

6. The method according to claim 4, wherein in a step 1), from a first signal strength S₁ for the smallest diameter D₁, the first degree of contamination G₁ of the optical element within the smallest diameter D₁ is inferred, and from the first signal strength S₁, an expected signal contribution C₂ in a second signal strength S₂ of a next larger diameter D₂ is determined by contaminants of the optical element within the smallest diameter D₁, and
in further steps j) from a respective corrected signal strength KSⱼ=Sⱼ−Cⱼ for the jth diameter Dⱼ to the respective degree of contamination Gⱼ of the optical element in the area between the jth diameter Dⱼ and the (j−1) th diameter Dⱼ₋₁ is inferred, and from the signal strength Sⱼ or from the first signal strength Sᵢ to the signal strength Sⱼ, a respective expected signal contribution Cⱼ₊₁ in the signal strength Sⱼ₊₁ of a next larger diameter Dⱼ₊₁ is determined by a contamination of the optical element within the diameter Dⱼ.

7. The method according to claim 6, wherein the respective expected signal contributions Cⱼ are determined at least approximately according to
$${C}_{j} = {S}_{j - 1} * {[ {D}_{j - 1} / {D}_{j} ]}^{2} .$$

8. The method according to claim 6, wherein the degrees of contamination G₁ to G_{N} are determined at least approximately according to
$${G}_{1} = F * {{S}_{{1}^{*}} [ {D}_{1} ]}^{2} and$$
$${G}_{j} = F * {KS}_{j} * [ {( {D}_{j} )}^{2} - {( {D}_{j - 1} )}^{2} ] ,$$
where F is a proportionality constant.

9. The method according to claim 4, wherein the first degree of contamination G₁ and the respective degree of contamination Gⱼ are converted into remaining availabilities V₁, Vⱼ within the smallest diameter D₁ for V₁ or within the area between Dⱼ and Dⱼ₋₁ for a respective Vⱼ,
wherein the first degree of contamination Gᵢ and the respective degree of contamination Gⱼ are assigned maximum values M₁ and Mⱼ, at which point laser processing becomes no longer usable and the remaining availabilities V₁, Vⱼ are calculated as
$${V}_{1} = 1 - {G}_{1} / {M}_{1} and$$
$${V}_{j} = 1 - {G}_{j} / {M}_{j}$$

10. The method according to claim 1, wherein, before a further evaluation of the signal strengths Sᵢ, the signal strengths Sᵢ are adjusted for a bias by subtracting from the respective signal strength Sᵢ a basic signal strength Bᵢ, which was obtained with the optical element in a contamination-free state with the corresponding laser beam with the diameter Di.

11. A method for operating a laser processing device, the method comprising:
checking an optical element of the laser processing device for contaminants, wherein the checking of the optical element of the laser processing device for contaminants is carried out according to the method of claim 1,
making a decision based on a result of the checking as to whether a scheduled process of laser processing a workpiece is to be carried out with the laser processing device or not, wherein in the decision as to whether the scheduled process is to be carried out or not, at least the information about the location-dependent contaminant of the optical element and information about the diameter(s) of the laser beam on the optical element to be used in the scheduled process are taken into account.

12. A method for operating a laser processing device, the method comprising:
checking an optical element of the laser processing device for contaminants, wherein the checking of the optical element of the laser processing device for contaminants is carried out according to the method of claim 1, and
in cases in which the information about the location-dependent contaminant of the optical element shows that relevant contaminants are present only in a radial edge area of the optical element but not in a central region of the optical element, carrying out laser processing of workpieces in which the diameter of the laser beam at the optical element remains within the central region.

13. The method according to claim 11, wherein the checking the optical element of the laser processing device for contaminants is performed:
after each maintenance or repair on a laser processing head of the laser processing device; and/or
after each predetermined operating time of the laser processing device; and/or
on each start-up of the laser processing device; and/or
before each start of a new process for the laser processing of the workpiece, and/or
on manual triggering.

14. A laser processing device comprising:
a laser source for providing a laser beam,
an optical element through which the laser beam passes,
an adjusting device for adjusting a diameter of the laser beam at the optical element,
an optical sensor for measuring scattered light emanating from the optical element, and
an electronic control device,
wherein the electronic control device is configured to carry out, in an automated sequence, a method for checking the optical element of the laser processing device for contaminants according to claim 1, and
wherein the electronic control device is configured to successively set different diameters Dᵢ of the laser beam at the optical element for the N individual measurements using the adjusting device, and to determine an associated signal strength Sᵢ at the optical sensor with the respective diameter Dᵢ.

15. The laser processing device according to claim 14, wherein the laser processing device is a laser cutting device.
